(19) United States
(12) Patent Application Publication
(10) Pub. No.: US 2003/0235206 A1
(43) Pub. Date: Dec. 25, 2003

(54) Dual proxy approach to TCP performance improvements over a wireless interface

(75) Inventor: Howard A. Heller, Indialantic, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: TANTIVY COMMUNICATIONS, INC.

(21) Appl. No.: 09/850,531

(22) Filed: May 7, 2001

Related U.S. Application Data
(60) Provisional application No. 60/269,024, filed on Feb. 15, 2001.

(51) Int. Cl. H04Q 7/00

(52) U.S. Cl. 370/467; 370/329

(57) ABSTRACT

A dual split-TCP connection for improving throughput in a data transmission system containing a wireless link is described. A pair of gateways are individually associated with a subscriber unit and a base station on opposite sides of the wireless link. The gateways respectively form spaced TCP proxy terminations for a pair of terminal machines, such as an end user machine and a server, between which data packets are exchanged over the system. Transmission over the wireless link itself employs an optimized wireless protocol or another non-TCP protocol such as UDP. Such elimination of the use of TCP over the wireless link minimizes delays attributable, e. g., to false readings of congestion on such link and the consequent unnecessary triggering of TCP congestion control/slow start mechanisms.

### BACKGROUND OF THE INVENTION

This invention relates to wireless communication systems such as cellular packet networks, and more particularly to methods of and apparatus for improving data throughput in such systems.

In communication systems for the transmission of data packets between an end user machine and a server, it is now common to employ wireless links that include a subscriber unit and a base station in mutual radio communication. The subscriber unit is coupled to the end user machine and the base station is coupled to the server.

Any discontinuities in the wireless data path can cause data packet loss which results in missing or delayed acknowledgment signals between the end user machine and the server. This is true whether packets are destined for the end user machine or the server. In the usual case where a TCP connection extends through the wireless link, TCP interprets such packet loss as network congestion, even though packet losses in a wireless environment are most often caused by signal loss and temporary disconnects. This increases the likelihood that the applicable TCP protocols at either end of the network connection will invoke congestion avoidance/slow start modes at the server, leading to a drop in data throughput in the system.

In an attempt to alleviate such problems, arrangements have been devised involving split TCP connections between the server and the end user machine. Such arrangements, exemplified in Brown et al, “M-TCP: TCP for Mobile Cellular Networks”, Dept. of Computer Science, University of South Carolina (Jul. 29, 1997), a wired TCP connection from the server is terminated at the wireless link, and a separate TCP connection is instantiated over the wireless link. Since TCP is still used over the wireless link, many of the above-mentioned inefficiencies are still present. Also, attendant requirements of constantly assigning channel capacity for TCP acknowledgments over such link and of maintaining overhead associated with TCP/IP headers for each packet of the transmitted data are unchanged. This places severe limits on the throughput improvement that is obtainable with such arrangements.

### SUMMARY OF THE INVENTION

The problems that result from the use of the TCP protocol over the wireless link are overcome with the methods and apparatus of the present invention, in which the TCP connection is split into two TCP connections separated by a non-TCP connection over the wireless link. A first TCP proxy gateway is interposed on the subscriber unit side of the wireless link, and a second TCP proxy gateway is interposed on the base station side. In response to a TCP connection request from the end user machine, the first gateway intelligently identifies the destination data in the TCP requests and establishes, between the end user machine and the subscriber unit, a first TCP connection that, as viewed by the end user machine, replicates a TCP connection between the end user machine and the server. The first gateway also functions to generate, from the TCP connection request message, a modified connection request message in a selected wireless protocol format, which is transmitted over the wireless link to the second gateway. The second gateway re-generates the TCP connect request message to establish, between the second gateway and the server, a second TCP connection. As viewed by the server, such second TCP connection replicates a TCP connection to the end user machine. Such dual split proxy arrangement is completely transparent to the end user machine and the server.

With this improved arrangement, any data packets transmitted in either direction once such split proxy connection is established will employ the TCP protocol only over the wired portion of the data communication network; the TCP protocol is eliminated entirely from the wireless link. During transmission over the wireless portion of the network, the data packets utilize the selected wireless protocol.

Since the TCP protocol is used only in the wired portion of the system, the TCP corrective mechanisms that would otherwise be triggered in response to temporary disconnects that occur over the wireless link are not present. In addition, TCP acknowledgments are eliminated over the wireless link, thereby alleviating the need to assign reverse channels for this purpose. The overhead otherwise necessary to encapsulate the data packets with TCP/IP headers for transmission over the wireless link is also eliminated.

### BRIEF DESCRIPTION OF THE DRAWING

The invention is further illustrated in the following detailed description taken in conjunction with the appended drawing, in which:

FIG. 1 is a block diagram of a wireless data communication system in which the dual split proxy gateway arrangement of the invention may be incorporated;

FIG. 2 is a block diagram illustrating the wireless data communication system of FIG. 1 after incorporation of the dual split proxy gateway arrangement of the invention;

FIG. 3 is a block diagram of an embodiment of a first gateway of the invention as incorporated on the subscriber unit side of the wireless link;

FIG. 4 is a block diagram of an embodiment of a second gateway of the invention as incorporated on the base station side of the wireless link;

FIG. 5 is a schematic representation of the transmission protocols employed in various portions of the network of FIG. 2; and

FIG. 6 is a flowchart representing message transmission between the end user machine and the server in the arrangement of FIG. 2.

### DETAILED DESCRIPTION

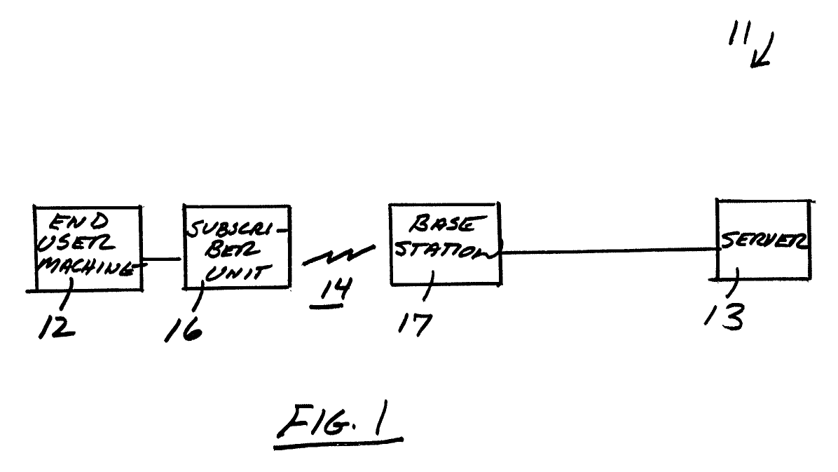

Referring to the drawing, FIG. 1 shows a data communication system 11, illustratively a cellular packet network, for the two-way transmission of digital data packets between an end user machine 12 and a server 13, which may be an Internet server. The system 11 includes a wireless link 14 that employs a subscriber unit 16, which typically includes a wireless modem, coupled to the end user machine 12 through a conventional wired network (not shown). The end user machine may be a laptop computer, a portable computer, a personal digital assistant, or the like, which may be moved from place to place.

The link 14 also includes a base station 17 which is in radio communication with the subscriber unit 16. The base station 17 is coupled to the server 13 through another conventional wired network (not shown)

Two-way data packet communication between the end user machine 12 and the server 13 is conventionally set up by utilizing suitable application software (not shown) associated with the machine 12 to generate TCP connection request messages which bear the IP destination address of the server 13. Once a TCP connection is established as a result of such request, the resulting TCP session may be carried out in a bi-directional manner using conventional TCP protocols. When such TCP session is in effect, successively numbered data packets from one of the machines 12 and 13, typically Internet protocol (IP) data packets, are conventionally encapsulated with TCP headers, verification bits, etc., and transmitted over the TCP connection to the other machine.

Successive bytes in the transmitted data packets from the sending machine will, in further accordance with applicable TCP protocols, trigger successive acknowledgment signals from the receiving machine at the other end of the established TCP connection. Such acknowledgment signals are transmitted to the sending machine over the same TCP connection.

In general, wireless transmission paths exemplified by the link 14 are susceptible to discontinuities, propagation delays, bit errors and the like which are much greater than those exhibited by the wired portion of the network. As a result, acknowledgment signals from the receiving end of the TCP connection may not arrive as expected at the sending machine within an expected time, if at all. In such case, the TCP protocols governing the connection in question conventionally trigger congestion control and/or slow-start modes at the sending machine which can significantly cut down throughput of data packets from such machine.

Several attempts have been made in the prior art to alleviate such problems by dividing the TCP connection into two parts through a single split on the data communication network. In a typical embodiment of this split as presented in the above-mentioned Brown et al article, the TCP connection is split on the base station side of the wireless link. The effect of such prior art arrangements on throughput is severely limited because one of the two TCP connections extends through the wireless link. The TCP protocols applicable over such connection will still respond to signal loss and temporary disconnections over the traversed wireless link by evoking the TCP congestion control mechanisms at the sending machine even when the receiving machine is prepared to receive normal data flow. In addition, the problems of extensive channel allocation requirements and significant header overhead that accompany any TCP connection through a wireless link are still present, as is the necessity of loading special software on the end user machine to help implement the split connection.

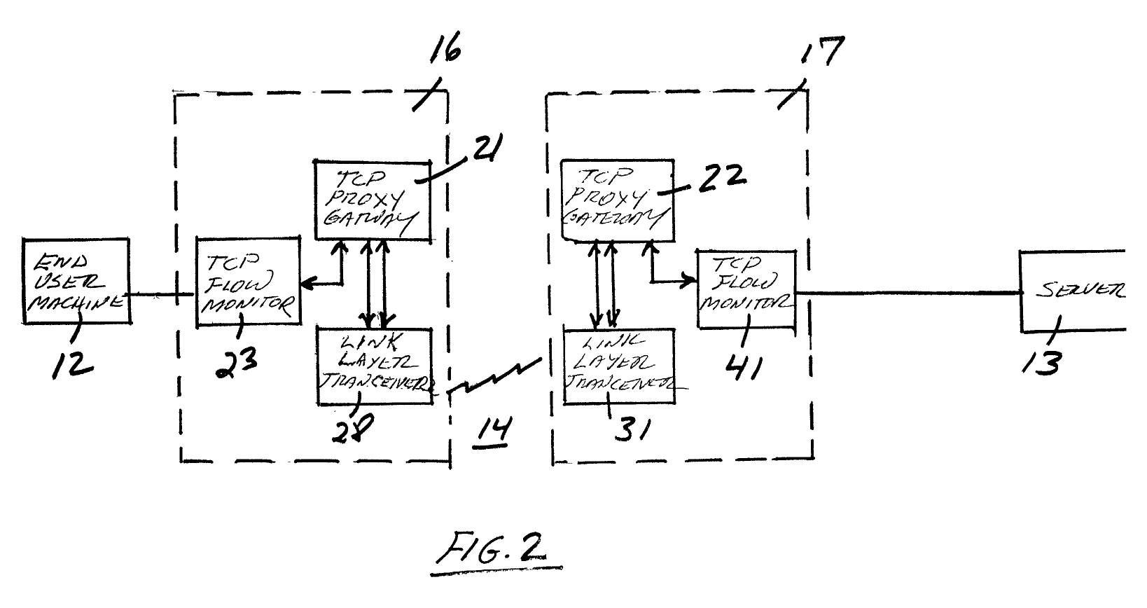

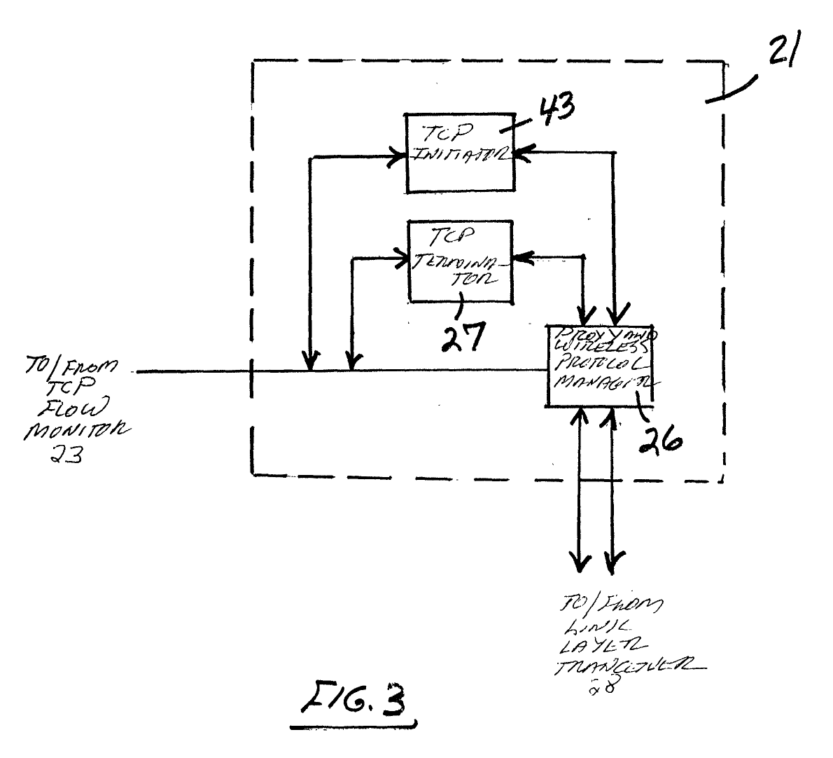

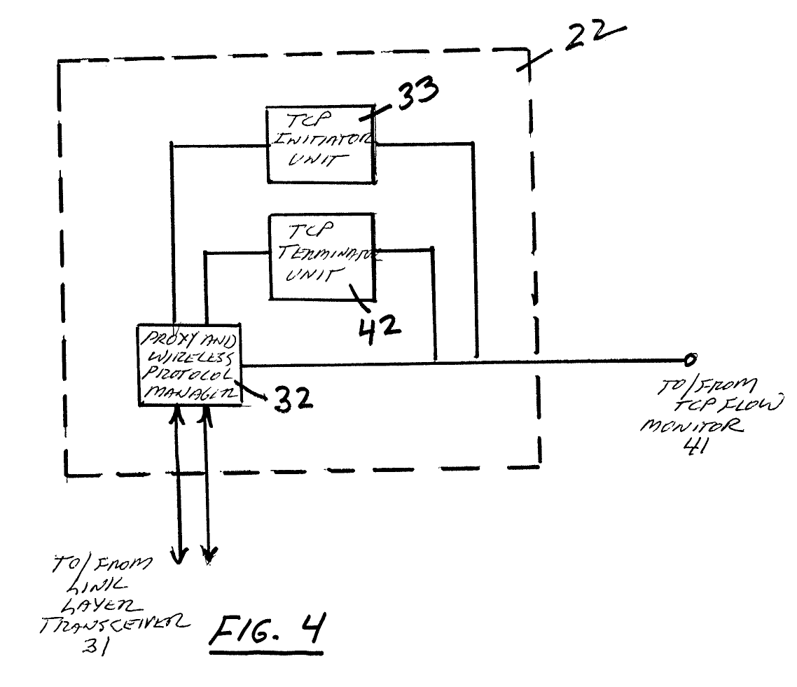

In accordance with the invention, a dual-split TCP proxy capability is incorporated in the network 11 of FIG. 1 in the manner set forth below in connection with FIGS. 2-4. Such capability simulates a conventional end-to-end connection between the end user machine 12 and the server 13 as viewed by each of such terminal machines while totally eliminating the use of the TCP protocol through the wireless link 14. A pair of TCP proxy gateways 21 and 22, to be described in relevant part in connection with FIGS. 3 and 4, are associated with the subscriber unit 16 and the base station 17, respectively. In the arrangement shown in FIG. 2, the gateway 21 is represented as being incorporated in the subscriber unit 16, but such gateway 21 may also be a separate unit associated with, and located on the same side of the wireless link 14 as, the subscriber unit 16. In like manner, the gateway 22 is shown as an integral part of the base station 17, but it may be alternatively embodied as a separate unit associated with, and located on the same side of the wireless link 14 as, the base station 17. (In other cases, not specifically shown in the drawing, where a plurality of spaced base stations are associated with a particular wireless subsystem, the gateway 22 may be associated with all of such base stations.)

TCP connection request packets transmitted from the end user machine 12 to establish a TCP session with the server 13 are intercepted by a TCP flow monitor 23 at the subscriber unit 16. As shown best in FIG. 3, the monitor 23 directs the TCP connection request packets to a proxy and wireless protocol manager 26 (hereafter “PWPM 26”) in the gateway 21. The PWPM 26 records the TCP connection information in the incoming request packets, including but not limited to the IP addresses of the end user machine 12 and the server 13, and establishes a small session identifier that is mapped to such addresses. Utilizing such information, the PWPM 26 activates a local TCP terminator unit 27 to establish a TCP end point for the connection requested by the machine 12. The PWPM 26 assigns the server IP address to such end point so that the TCP connection thus established appears to the end user machine 12 as a replica of a direct TCP connection with the server 13. The TCP connection established by the gateway 21 participates in standard TCP protocol exchanges with the end user machine 12, including the generation of acknowledgment signals for connection request messages and for subsequent data messages originating at the machine 12 and intercepted by the monitor 23.

The TCP terminator unit 27 removes the TCP framing of the intercepted connection request packets from the machine 12, and transfers the data in each such request packet to the PWPM 26. The PWPM 26 generates modified connection request packets in which the transferred data from each packet is encapsulated with a header appropriate for the transmission of such modified packets over the wireless link 14 in a wireless protocol format selected by the PWPM 26. Such wireless protocol header contains the above-mentioned session identifier, the sequence number assigned to such packet, and other information that may be necessary to optimally format the packet in accordance with the selected wireless protocol, which may illustratively be a link layer protocol or other non-TCP protocol such as UDP. (For purposes of this description, formatting in accordance with a link layer protocol will be assumed). Because of the small size of the session identifier, the wireless protocol header can be considerably smaller than the header that would be necessary for the transmission of TCP connection request messages over the wireless link.

The PWPM 26 forwards the modified connection request packets to a conventional link layer transceiver 28, which transmits the modified packets over the wireless link 14 to a corresponding link layer transceiver 31 (FIG. 2) in the base station 17. As shown best in FIG. 4, the transceiver 31 forwards the modified packets to a second proxy and wireless protocol manager 32 (hereafter “PWPM 32”) in the second gateway 22. The PWPM 32 extracts the session identifier information from the wireless protocol headers of the incoming modified packets and commands a local TCP initiator unit 33 to remove such headers from the packets. The initiator unit 33 then encapsulates the packet data with TCP headers bearing the IP addresses of the end user machine12 and the server 13 as derived from the extracted session identifier, thereby effectively reconstructing the original TCP connection request message from the machine 12. The initiator unit 33, and therefore the gateway 22, is assigned the IP address of the end user machine 12.

The initiator unit 33 forwards the reconstructed TCP connection request packets through a TCP flow monitor 41 (FIG. 2) to the server 13 to establish a second TCP connection between the gateway 22 and the server. Since the initiator unit 33 presents the IP address of the end user machine 12 to the server 13, the TCP connection just established between the gateway 22 and the server 13 will be a replica of an end-to-end connection between the end user machine 12 and the server 13. Therefore, like the above-described first TCP connection established between the machine 12 and the gateway 21, the second TCP connection can engage in all standard TCP protocol exchanges as if there were such a direct end-to-end connection between the server 13 and the machine 12. Such exchanges include the generation, at the initiator unit 33 (FIG. 4), of acknowledgment signals that would be generated by the end user machine 12 (FIG. 2) in response to the transmission of data packets from the server 13.

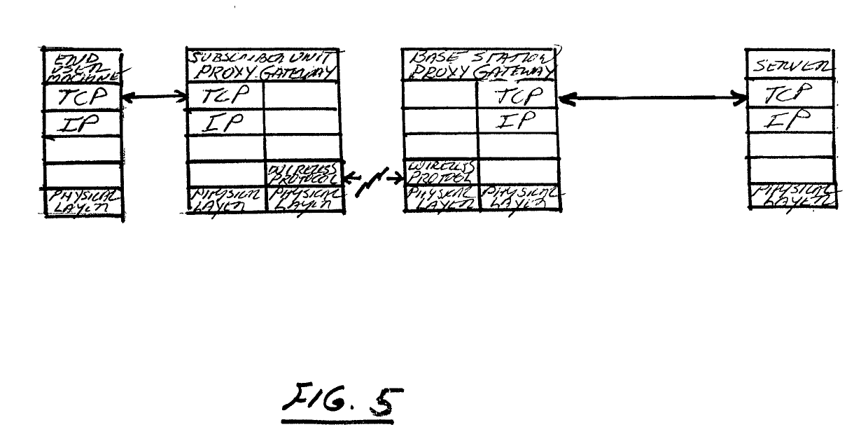

The diagram of FIG. 5 summarizes in schematic form the dual split proxy connections just described in connection with FIGS. 2-4.

Once the system illustrated in FIG. 2 has been configured to establish dual split proxy connections in accordance with the invention, data packets can flow over such system in a bi-directional manner via the first and second TCP wired paths and the intervening wireless link layer. For purposes of the following description, the data flow will be assumed to be from the server 13 to the end user machine 12.

Data packets in TCP format transmitted by the server 13 are intercepted by the flow monitor 41 at the base station 17. If the flow monitor 41 senses that the IP destination address of the data packets from the server 13 matches the IP address of the end user machine 12 as presented to the server by gateway 22, the monitor 41 directs such packets to the PWPM 32 (FIG. 4) in the gateway unit 22. The PWPM 32 commands the TCP initiator unit 33 to remove the TCP framing from the data packets. The PWPM 32 receives the unencapsulated data from the initiator unit 33, appends a small wireless protocol header to such data, and transmits the data packets as so converted to the gateway unit 21 in the subscriber unit 16 through the transceiver 31, the wireless link 14 (FIG. 2) and the transceiver 28. Upon receipt of such converted data packets at the gateway 21, the PWPM 26 (FIG. 3) extracts the relevant session identifier from, and instructs the TCP terminator unit 27 to remove, the wireless protocol headers from the converted data packets. The terminator unit 27 encapsulates the packet data in TCP frames containing source and destination IP addresses dictated by the session ID information extracted from the wireless protocol headers. The TCP packets as so reconverted are then routed through the flow monitor 23 to the end user machine12 over the previously established TCP connection.

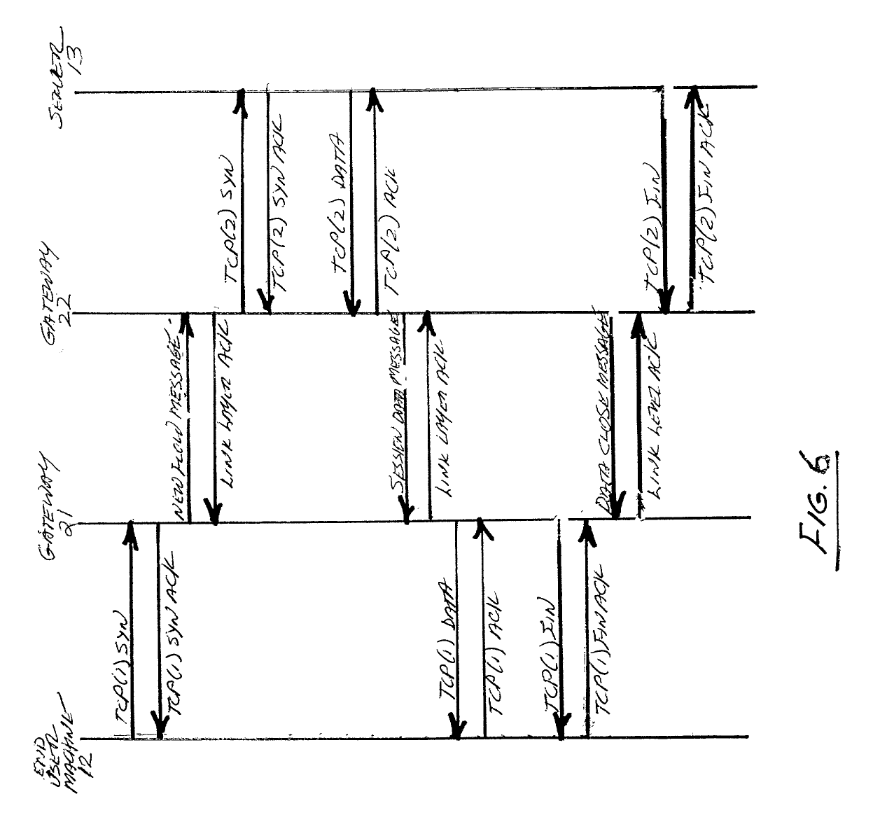

FIG. 6 shows an illustrative sequence of messages and data through the dual split proxy arrangement in accordance with the invention. A TCP connection request in the form of a TCP (1) SYN message bearing the address of the server 13 is initially transmitted from the end user machine 12. Such connection request is in the form of packets encapsulated in TCP frames. The request packets are intercepted by the gateway 21 which sets up the first TCP connection and sends a TCP (1) SYN ACK acknowledgment signal back to the end user machine 12. Since the end point established at the gateway unit bears the IP address of the server 13, the TCP (1) SYN ACK signal received by the machine 12 is the same as if the acknowledgment had originated with the server 13. The gateway unit 21 generates, from the TCP (1) SYN signal, a new flow message which is sent over the wireless link to the gateway unit 22 in the form of modified packets encapsulated with a wireless protocol header. A link layer acknowledgment is returned. The gateway unit 22 also removes the wireless protocol frames from the modified connection request packets, encapsulates it with TCP frames, and transmits the resulting re-generated TCP (2) SYN signal to the server 13 to set up the second TCP connection. The server returns an acknowledgment designated TCP (2) SYN ACK to the gateway unit 22 as a proxy for the end user machine 12.

Assuming that the initial data flow of data is to be from the server 13 to the end use machine 12 after the dual split connection is set up, data packets TCP (2) DATA are applied to the gateway unit 22 from such machine. The gateway unit 22 returns a TCP (2) ACK to the server13 as a proxy for the end user machine 12. The data packets are converted at the gateway unit 22 to wireless protocol form and sent in the form of a session data message to the gateway unit 21. A link layer acknowledgment is returned. When the session data message reaches the gateway 21, such gateway reconverts the message to TCP format and sends it, as a proxy for the server 13, to the end user machine in the form of a TCP (1) DATA message. The end user machine then returns a TCP (1) ACK.

It will be understood that identical flows of data can take place in the opposite direction. Also, it will be understood that either of the terminal machines (illustratively the server 13) can terminate a TCP session in a conventional manner. Specifically, in FIG. 6, the server 13 initiates a termination message depicted as TCP (2) FIN, which is acknowledged by the gateway unit 22 with a TCP (2) FIN ACK signal as a proxy for the end user machine 12. Such message is converted at the gateway unit 22 to wireless protocol format and forwarded as a data close message over the wireless link. The TCP initiator unit 33 (FIG. 4) in the gateway 22 is also commanded to close the TCP connection to the server.

The data close message packets are re-converted at the gateway unit 21 to TCP format, and are routed to the end user machine 12 as TCP (1) FIN packets (FIG. 6) over the first TCP connection. Such data close message packets are acknowledged at the machine 12 with a TCP (1) FIN ACK as shown, and the TCP terminator unit 27 (FIG. 3) in the gateway 21 is commanded to close the TCP connection to the end user machine.

An additional advantage of the dual split proxy arrangement of the invention over prior art split connection arrangements such as the one described in the above-mentioned article by Brown et al. is that no special software or configuration is necessary on the end user machine 12 (FIG. 2). Any required special software is housed within the applicable gateway units 21 and 22, respectively.

A still further advantage is that the wireless protocol selected by the applicable PWPM for the transmission of messages over the wireless link can be separately optimized for the link layer without the necessity of taking any TCP parameters into account. It will be appreciated, however, that such selected wireless protocol should still be conventionally adapted to support retransmissions in the event of lost data over the wireless link. The number of successive retransmissions to be attempted before application of a timeout mechanism may be configured via suitable commands supplied to one of the link layer transceivers by the applicable PWPM. If it is determined that a packet cannot be transmitted through the wireless link after the configured number of retransmissions, the link layer can be ordered to send, to the PWPM, a suitable transmit error indication that specifies the session identifier of the message that failed transmission. Such error indication could be used in a conventional manner by the PWPM to terminate the data flow by sending suitable commands to the associated local TCP initiator or terminator unit and by sending a corresponding message via the link layer to the PWPM on the other side of the wireless link. In such case, a configurable timer (not shown) may be utilized by the first PWPM to abort the flow in the event that a link layer acknowledgment is not received from the other side of the wireless link within a preset time.

In the foregoing, the invention has been described, in part, in connection with an exemplary embodiment thereof. Many variations and modifications will now occur to those skilled in the art. For example, the dual-split TCP connection of the invention may also be established from the opposite end of the data transmission system11. In such case, the first TCP connection would extend between the server 13 and the gateway 22, and the second TCP connection would extend between the gateway 21 and the end user machine 12. The mechanics of forming such latter connections will mirror those described above, except that (1) the end point of the first TCP connection as presented to the server13 would be implemented by a second TCP terminator unit 42 (FIG. 4) in the gateway 22, and (2) the starting point of the second TCP connection as presented to the end user machine 12 would be implemented by a second TCP initiator unit 43 (FIG. 3) in the gateway 21. It is accordingly desired that the scope of the appended claims not be limited to or by the specific disclosure herein contained.

What is claimed is:

1. In a data transmission system including a wireless link for transmitting packets, generated in TCP format, between a first machine and a second machine, the wireless link comprising first and second transceivers in mutual radio communication and respectively associated with the first and second machines, a method of configuring the system to increase data throughput, which comprises the steps of:
establishing between the first machine and the first transceiver, in response to TCP connection request packets transmitted from the first machine, a first TCP connection replicating a TCP connection between the first and second machines;
deriving, from such TCP connection request packets, modified packets exhibiting a selected wireless protocol format;
forwarding the modified packets over the wireless link; and
establishing between the second transceiver and the second machine, in response to the forwarded modified packets, a second TCP connection replicating a TCP connection between the first and second machines.

2. In a data transmission system including a wireless link for transmitting packets, generated in TCP format, between a first machine and a second machine, the wireless link comprising first and second transceivers in mutual radio communication and respectively associated with the first and second machines, a method of configuring the system to increase data throughput, which comprises the steps of:
establishing between the first machine and the first transceiver, in response to TCP connection request packets transmitted from the first machine, a first TCP connection replicating a TCP connection between the first and second machines;
deriving, from respective packets transmitted from the first machine over the first TCP connection, modified packets exhibiting a selected wireless protocol format;
transmitting, over the wireless link, modified packets derived from the TCP connection request packets; and
establishing between the second transceiver and the second machine, in response to transmitted modified packets derived from the TCP connection request packets, a second TCP connection replicating a TCP connection between the first and second machines.

3. In a data transmission system including a wireless link for transmitting first data packets generated in TCP format between a first machine and a second machine, the wireless link comprising first and second transceivers in mutual radio communication and respectively associated with the first and second machines, a method for optimizing data throughput on the system, which comprises the steps of:
establishing between the first machine and the first transceiver, in response to first TCP connection request packets from the first machine, a first TCP connection replicating a TCP connection between the first and second machines;
on the first transceiver side of the wireless link, generating, from the first TCP connection request packets, second connection request packets encapsulated in accordance with a selected wireless protocol;
transmitting the second connection request packets over the wireless link;
establishing between the second transceiver and the second machine, in response to the transmitted second connection request packets, a second TCP connection replicating a TCP connection between the first and second machines;
on the second transceiver side of the wireless link, deriving, from first data packets transmitted by the second machine over the second TCP connection, second data packets encapsulated in accordance with the selected wireless protocol;
transmitting the second data packets over the wireless link;
on the first transceiver side of the wireless link, re-generating the first data packets from the second data packets; and
transmitting the re-generated first data packets to the first machine over the first TCP connection.

4. A method as defined in claim 3, further comprising, in combination, the steps of converting into third data packets, on the first transceiver side of the wireless link, first data packets transmitted by the first machine over the first TCP connection, the third data packets being encapsulated in accordance with the selected wireless protocol; transmitting the third data packets over the wireless link; and re-converting the transmitted third data packets back into first data packets on the second transceiver side of the wireless link for application to the second machine over the second TCP connection.

5. In a data transmission system including a wireless link for transmitting first data packets between a first machine and a second machine, the wireless link comprising a mobile subscriber unit connected to the first machine and a base station coupled to the second machine and in radio communication with the subscriber unit, the first data packets being encapsulated in TCP frames, a method for optimizing data throughput on the system, which comprises the steps of:
establishing, between the first machine and the subscriber unit, a first TCP connection replicating a TCP connection between the first and second machines;
establishing, between the base station and the second machine, a second TCP connection replicating a TCP connection between the first and second machines;
on the base station side of the wireless link, converting first data packets transmitted from the second machine over the second TCP connection into second data packets encapsulated in accordance with a selected wireless protocol;
transmitting the second data packets over the wireless link;
on the subscriber unit side of the wireless link, re-converting the second data packets back into first data packets; and
transmitting the re-converted first data packets to the first machine over the first TCP connection.

6. A method as defined in claim 5, further comprising, in combination, the steps of converting into third data packets, on the subscriber unit side of the wireless link, first data packets transmitted by the first machine over the first TCP connection, the third data packets being encapsulated in accordance with the selected wireless protocol; transmitting the third data packets over the wireless link; and re-converting the transmitted third data packets back into first data packets on the base station side of the wireless link for application to the second machine over the second TCP connection.

7. In a data transmission system including a wireless link for transmitting first data packets between a first machine and a second machine, the wireless link comprising first and second transceivers in mutual radio communication and respectively associated with the first and second machines, apparatus for configuring the system to increase data throughput, which comprises:
first means associated with the first transceiver and responsive to TCP connection request packets from the first machine for establishing, between the first machine and the first transceiver, a first TCP connection replicating a TCP connection between the first and second machines for the transmission of the first data packets;
first means associated with the first transceiver for generating, from the TCP connection request packets, modified connection request packets encapsulated in accordance with a selected wireless protocol for transmission over the wireless link; and
second means associated with the second transceiver and responsive to the transmitted modified connection request packets for establishing, between the second transceiver and the second machine, a second TCP connection replicating a TCP connection between the first and second machines.

8. Apparatus as defined in claim 7, further comprising second means associated with the second transceiver for converting first data packets transmitted by the second machine over the second TCP connection into second data packets encapsulated in accordance with the selected wireless protocol for transmission over the wireless link, and first means associated with the first transceiver for re-converting the transmitted second data packets back into first data packets for application to the first machine over the first TCP connection.

9. Apparatus as defined in claim 8, further comprising third means associated with the first transceiver for converting first data packets transmitted by the first machine over the first TCP connection into third data packets encapsulated in accordance with the selected wireless protocol for transmission over the wireless link, and second means associated with the second transceiver for re-converting the transmitted third data packets back into first data packets for application to the second machine over the second TCP connection.

10. In a data transmission system including a wireless link for transmitting first data packets between a first machine and a second machine, the wireless link comprising first and second transceivers in mutual radio communication and respectively associated with the first and second machines:
first means associated with the first transceiver and responsive to TCP connection request packets from the first machine for establishing, between the first machine and the first transceiver, a first TCP connection replicating a TCP connection between the first and second machines;
first means associated with the first transceiver for deriving, from the TCP connection request packets, modified connection request packets encapsulated in accordance with a selected wireless protocol for transmission over the wireless link;
second means associated with the second transceiver and responsive to the transmitted modified connection request packets for establishing, between the second transceiver and the second machine, a second TCP connection replicating a TCP connection between the first and second machines;
second means associated with the second transceiver for converting first data packets, transmitted by the second machine over the second TCP connection, into second data packets encapsulated in accordance with the selected wireless protocol for transmission over the wireless link; and
first means associated with the first transceiver for re-converting the transmitted second data packets back into first data packets for application to the first machine over the first TCP connection.

11. A data transmission as defined in claim 10, further comprising, in combination, third means associated with the first transceiver for converting first data packets transmitted by the first machine over the first TCP connection into third data packets encapsulated in accordance with the selected wireless protocol for transmission over the wireless link, and second means associated with the second transceiver for re-converting the transmitted third data packets back into first data packets for application to the second machine over the second TCP connection.

12. In a data transmission system including a wireless link for transmitting first data packets between a first machine and a second machine, the wireless link comprising a mobile subscriber unit coupled to the first machine and a base station coupled to the second machine and in radio communication with the subscriber unit:
first means associated with the subscriber unit and responsive to TCP connection request packets from the first machine for establishing, between the first machine and the subscriber unit, a first TCP connection replicating a TCP connection between the first and second machines for transmission of first data packets;
first means associated with the subscriber unit for generating, from first TCP connection request packets from the first machine into modified connection request packets encapsulated in accordance with a selected wireless protocol for transmission over the wireless link;
first means associated with the subscriber unit for converting first data packets from the first machine into second data packets encapsulated in accordance with the selected wireless protocol for transmission over the wireless link;
second means associated with the base station and responsive to the transmitted modified connection request packets for establishing, between the base station and the second machine, a second TCP connection replicating a TCP connection between the first and second machines for the transmission of first data packets; and
first means associated with the base station for re-converting the transmitted second data packets back into first data packets for application to the second machine over the second TCP connection.

13. Apparatus as defined in claim 12, in which the first establishing means, the first generating means and the first converting means are incorporated in the subscriber unit.

14. Apparatus as defined in claim 12, in which the second establishing means and the first re-converting means are incorporated in the base station.

15. A data transmission system as defined in claim 12, further comprising, in combination, second means associated with the base station for converting first data packets transmitted by the second machine into third data packets encapsulated in accordance with the selected wireless protocol for transmission over the wireless link, and second means associated with the subscriber unit for re-converting the transmitted third data packets back into first data packets for application to the first machine over the first TCP connection.

16. Apparatus as defined in claim 15, in which the second converting means are incorporated in the base station.

17. Apparatus as defined in claim 15, in which the second re-converting means is incorporated in the subscriber unit.
